(19) United States
(12) Patent Application Publication
(10) Pub. No.: US 2026/0177232 A1
(43) Pub. Date: Jun. 25, 2026

(54) POWER SUPPLY AND ILLUMINATED HANDLE STRUCTURE THEREOF

(71) Applicant: ACBEL POLYTECH INC., New Taipei City (TW)

(72) Inventors: Yu-Heng LIN, New Taipei City (TW); Wei-Chieh HSIEH, New Taipei City (TW); Yung-Han KUO, New Taipei City (TW)

(73) Assignee: ACBEL POLYTECH INC., New Taipei City (TW)

(21) Appl. No.: 19/208,999

(22) Filed: May 15, 2025

Related U.S. Application Data
(60) Provisional application No. 63/654,116, filed on May 31, 2024.

(30) Foreign Application Priority Data
Dec. 30, 2024 (TW) 113151587

(51) Int. Cl. F21V 23/00; F21Y 113/00; F21Y 115/10

(52) U.S. Cl. CPC F21V 23/001; F21Y 2113/00; F21Y 2115/10

(57) ABSTRACT

A power supply and an illuminated handle structure thereof, and the illuminated handle structure includes a U-shaped handle and an illumination module. Two ends of the handle are securely attached to a panel of a casing. The illumination module has at least one light-emitting diode each being a Dual Inline-Pin (DIP) light-emitting diode and embedded in the two ends of the handle. In the present invention, the DIP light-emitting diodes are applied to replace surface-mount light-emitting diodes that have to be provided along with the flexible printed circuit board. Thus, in addition to significantly reducing material costs, damage caused during assembling process can also be reduced, thereby improving yield rate of the product and reducing manufacturing costs.

### BACKGROUND

### 1. Field of the Invention

The present invention relates to a power supply, especially to an illuminated handle structure of the power supply.

### 2. Description of the Prior Arts

Power supply is a device that is capable of transforming voltages of direct current or alternating current into stable direct current voltages required by electronic devices. In order to facilitate the assembler to install the power supply into the chassis of an electronic device (such as a server) with appropriate force to avoid damages to the power supply or other electronic components in the electronic device, a handle is mounted on the conventional power supply; furthermore, the handle has been designed to be illuminable to indicate a state of the power supply with light effects (such as a red light or a green light).

The conventional illuminated handle is mainly manufactured by mounting the Surface Mount Device (SMD) light-emitting diodes (LED), which are attached onto the flexible printed circuit board (FPC), into a handle made of a light transmitting material to achieve the purpose of making the handle glow.

Although the aforementioned design that is provided with FPC combined with SMD-LED may reduce the space occupied in the chassis, the cost is also high; furthermore, the sizes of the components required in manufacturing are small, and thus the components are prone to damage during assembling, leading to an increase in defect rate, such that the manufacturing cost would be further increased. Therefore, the conventional illuminated handle of the power supply still needs to be improved.

### SUMMARY

To overcome the shortcomings, the present invention provides a power supply and an illuminated handle structure thereof to mitigate or obviate the aforementioned problems.

The main objective of the present invention is to provide a power supply and an illuminated handle structure thereof that have low material costs and high structural reliability.

The illuminated handle structure is configured to be mounted on a casing of the power supply and comprises a handle and an illumination module. The handle is made of a light transmitting material and is U-shaped. The handle has two secure-connection ends and at least one installation recess. Each one of the two secure-connection ends includes an end surface. The at least one installation recess is recessed from the end surface of at least one of the two secure-connection ends. A recess wall is formed within each one of the at least one installation recess, and at least one snap-fitting recess is formed on the recess wall. The illumination module has at least one light-emitting diode each being a Dual Inline-Pin (DIP) light-emitting diode, and each one of the at least one light-emitting diode is detachably embedded in a corresponding one of the at least one installation recess of the handle. Each one of the at least one light-emitting diode includes a rim and multiple terminal pins. The rim surrounds and is formed on an outer wall surface of the at least one light-emitting diode, and snap-fits in the at least one snap-fitting recess of the corresponding installation recess. Each one of the terminal pins electrically connects with a cable.

In addition, the power supply comprises a casing, a fan, a receptacle, a transformer module, a direct current output connector, a control module, and an illuminated handle structure. The casing includes a panel. The fan is mounted at an inner side of the panel and exposed to an exterior of the casing through the panel. The receptacle is configured to receive an external power source. The transformer module is mounted in the casing and electrically connects with the receptacle, and the transformer module is configured to transform the external power source into a direct-current power source. The direct current output connector is electrically connected to the transformer module and configured to export the direct-current power source. The control module is configured to generate a controlling signal, and the controlling signal indicates an operating state of the power supply. The illuminated handle structure is mounted on the panel of the casing and electrically connects with the control module, and the illuminated handle structure is configured to show the operating state of the power supply according to the controlling signal via emitting a first colored light or a second colored light. Wherein, the illuminated handle structure comprises a handle and an illumination module. The handle is made of a light transmitting material and is U-shaped. The handle has two secure-connection ends and at least one installation recess. Each one of the two secure-connection ends includes an end surface. The at least one installation recess is recessed from the end surface of at least one of the two secure-connection ends. A recess wall is formed within each one of the at least one installation recess, and at least one snap-fitting recess is formed on the recess wall. The illumination module has at least one light-emitting diode each being a Dual Inline-Pin (DIP) light-emitting diode, and each one of the at least one light-emitting diode is detachably embedded in a corresponding one of the at least one installation recess of the handle. Each one of the at least one light-emitting diode includes a rim and multiple terminal pins. The rim surrounds and is formed on an outer wall surface of the at least one light-emitting diode, and snap-fits in the at least one snap-fitting recess of the corresponding installation recess. Each one of the terminal pins electrically connects with a cable.

In a preferable embodiment, the cable is a flexible flat cable, and the flexible flat cable electrically connects with each one of the terminal pins of the at least one light-emitting diode.

In a preferable embodiment, the at least one installation recess of the handle includes two installation recesses, and the two installation recesses are respectively recessed from the end surfaces of the two secure-connection ends.

In a preferable embodiment, the at least one light-emitting diode includes two light-emitting diodes, and the two light-emitting diodes are respectively embedded in the two installation recesses of the handle.

In a preferable embodiment, the at least one light-emitting diode includes one light-emitting diode, and the light-emitting diode is embedded in one of the at least one installation recess of the handle.

The illuminated handle structure of the power supply in this disclosure is provided with Dual Inline-Pin light-emitting diode to replace the Surface Mount Device light-emitting diode that has to be provided along with a flexible printed circuit board. Thus, in addition to significantly reducing material costs, damage caused during assembling process can also be reduced, thereby improving yield rate of the product and reducing manufacturing costs.

### BRIEF DESCRIPTION OF THE DRAWINGS

FIG. 1 is a perspective view of a first preferable embodiment of a power supply and an illuminated handle structure thereof in accordance with the present invention;

FIG. 2 is an exploded view of the power supply and the illuminated handle structure in FIG. 1;

FIG. 3 is a partial enlarged exploded view of the power supply and the illuminated handle structure in FIG. 1;

FIG. 4 is a cross-sectional side view of the power supply and the illuminated handle structure in FIG. 1;

FIG. 5 is a cross-sectional top view of the power supply and the illuminated handle structure in FIG. 1;

FIG. 6 is a cross-sectional side view of a second preferable embodiment of the power supply and the illuminated handle structure thereof in accordance with the present invention;

FIG. 7 is a perspective view of a third preferable embodiment of the power supply and the illuminated handle structure thereof in accordance with the present invention;

FIG. 8 is a perspective view of a fourth preferable embodiment of the power supply and the illuminated handle structure thereof in accordance with the present invention; and

FIG. 9 is an exploded view of the power supply and the illuminated handle structure in FIG. 8.

### DETAILED DESCRIPTION

Other objectives, advantages and novel features of the invention will become more apparent from the following detailed description when taken in conjunction with the accompanying drawings.

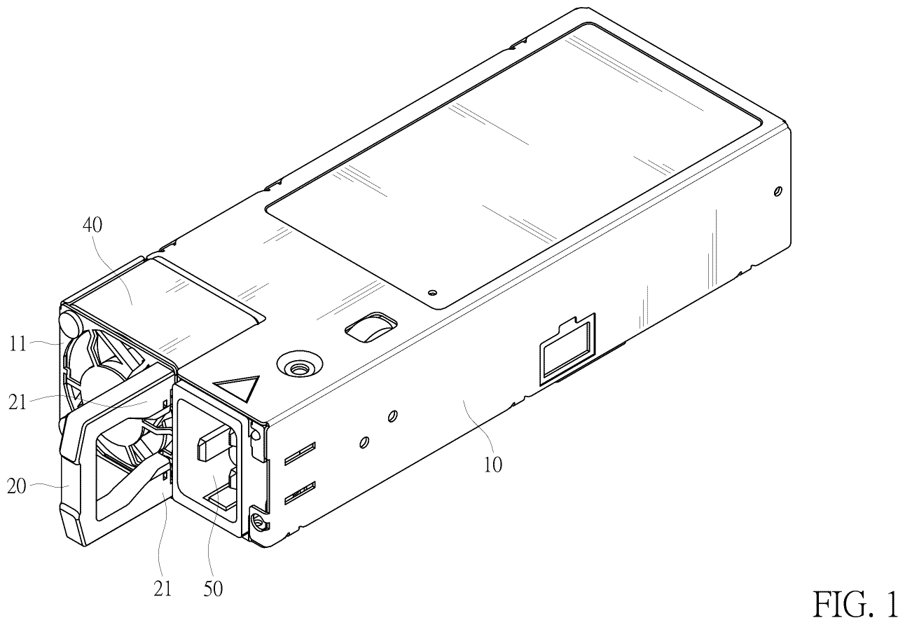

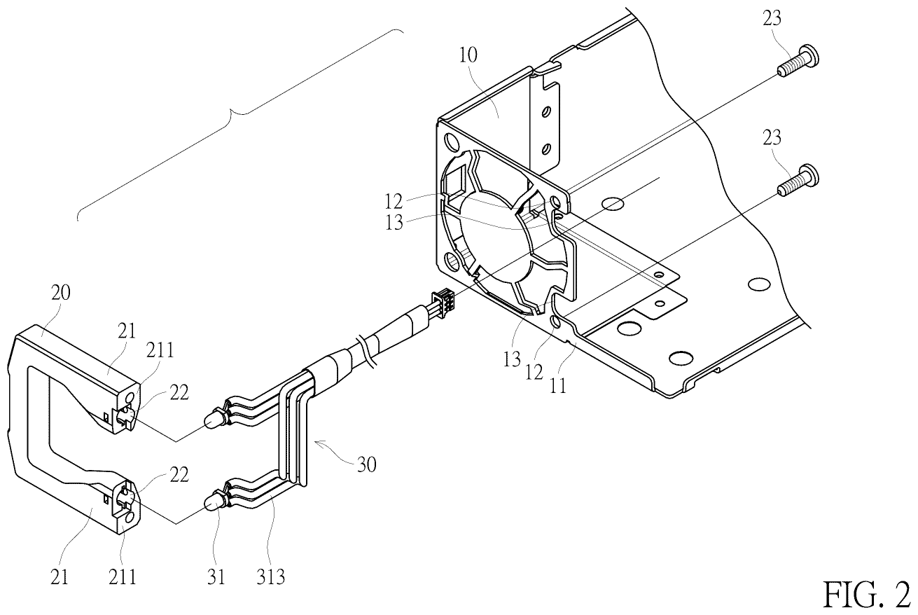

With reference to FIGS. 1 and 2, a power supply in accordance with the present invention comprises a casing 10. The length, width, and height of a size of the casing 10 may be respectively 185 mm (millimeter), 73.5 mm, and 40 mm, or respectively 185 mm, 60 mm, and 40 mm, or further respectively 265 mm, 73.5 mm, and 40 mm. A fan 40, a receptacle 50, a transformer module, and a direct current output connector may be mounted in the casing 10. The receptacle 50 is configured to receive an external power source. The external power source is input into the power supply via the receptacle 50, transforming from a high-voltage alternating current power source to a low-voltage and stable direct-current power source via the transformer module, and then supplies power to other electronic devices via the direct current output connector. The fan 40 is configured to dissipate the heat in the casing 10.

To be more precise, in some embodiments, the length, width, and height of the casing 10 may be respectively 185 mm, 73.5 mm, and 40 mm (hereinafter referred to as first casing size); in some other embodiments, the length, width, and height of the casing 10 may be respectively 265 mm, 73.5 mm, and 40 mm (hereinafter referred to as second casing size); and further in some other embodiments, the length, width, and height of the casing 10 may be respectively 185 mm, 60 mm, and 40 mm (hereinafter referred to as third casing size). The casing 10 which has the first casing size or the second casing size is capable of installing one or two of the fans 40, but the casing 10 of the third casing size is only capable of installing one fan 40. The receptacles provided in the casings 10 of the first casing size and the second casing size may be C14 inlet connectors supporting 277 VAC/380 VDC power input and output, inlet connectors supporting 277 VAC/380 VDC power input and output, input receptacle connectors supporting +54 VDC power input and configured to connect with a +54V input device, or input receptacle connectors supporting-48 VDC power input; the receptacle provided in the casing 10 of the third casing size may be a C14 inlet connector supporting 277 VAC/380 VDC power input and output, an inlet connector supporting 277 VAC/380 VDC power input and output, or an input receptacle connector supporting-48 VDC power input.

With reference to FIGS. 1 and 2, an illuminated handle structure of the power supply which is configured to be mounted on the aforementioned casing 10 in accordance with the present invention comprises a handle 20 and an illumination module 30.

The casing 10 has a panel 11, and the aforementioned fan 40 and receptacle 50 are mounted on an inner side of the panel 11, and exposed to an exterior of the casing 10 through the panel 11. Two secure-connection holes 12 and two installation holes 13 are disposed on the panel 11. The two secure-connection holes 12 are spaced from each other, and the two installation holes 13 are respectively disposed adjacent to the two secure-connection holes 12.

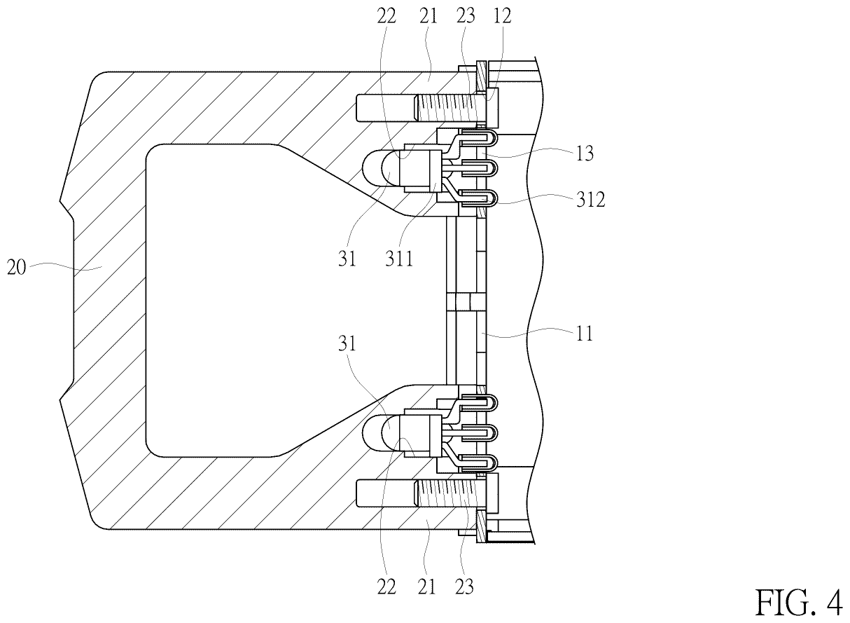

With reference to FIGS. 2 and 4, the handle 20 is U-shaped in appearance and made of a light transmitting material which is transparent or translucent. The handle 20 has two secure-connection ends 21 and two installation recesses 22.

The two secure-connection ends 21 extend toward the same direction, and each one of the secure-connection ends 21 includes an end surface 211. Each one of the end surfaces 211 corresponds to one of the secure-connection holes 12 and one of the installation holes 13 which are disposed adjacent to each other. The end surfaces 211 of the two secure-connection ends 21 abut on the panel 11 of the casing 10. Fasteners 23 are mounted through the two secure-connection holes 12 of the panel 11 and securely connected to the end surfaces 211 of the two secure-connection ends 21, thereby fixing the handle 20 on the casing 10.

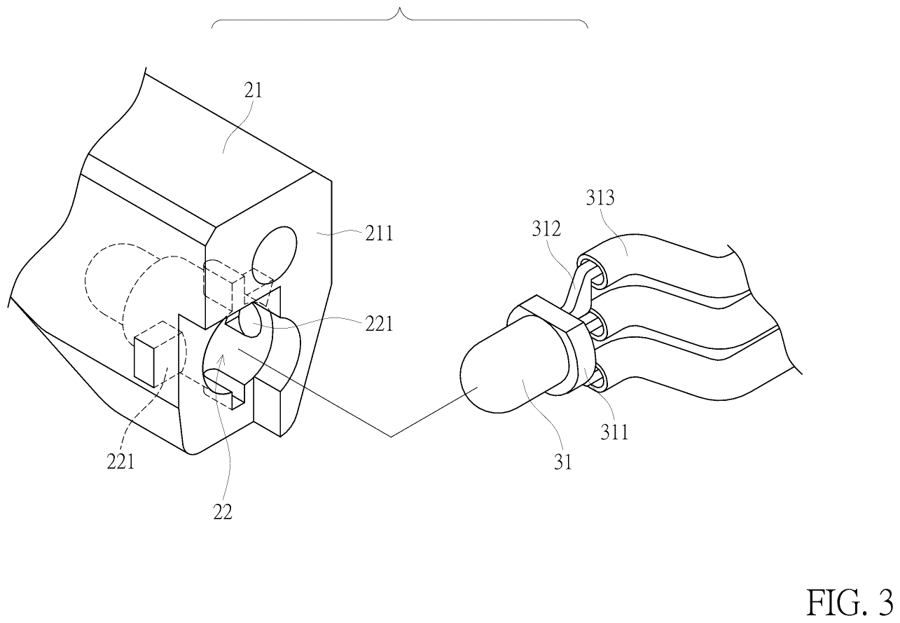

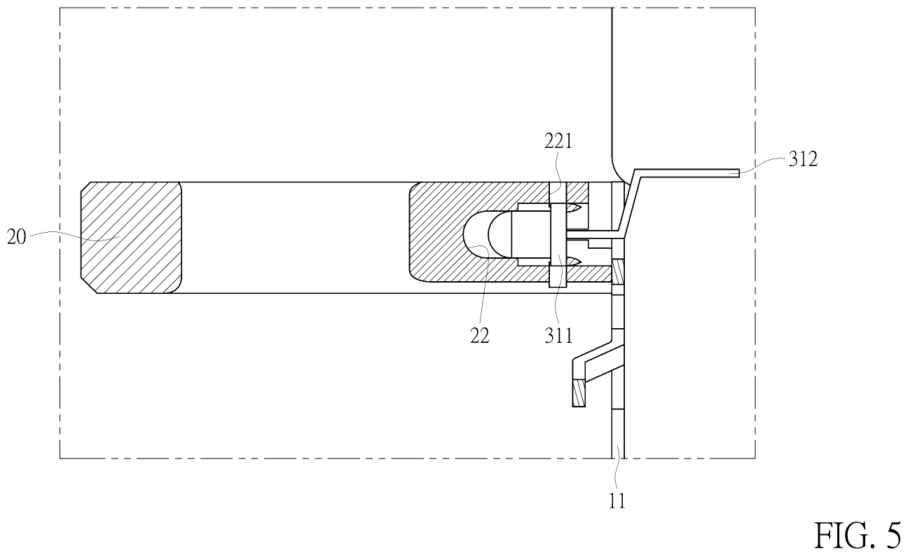

Further with reference to FIGS. 3 to 5, the two installation recesses 22 are respectively recessed from the end surfaces 211 of the two secure-connection ends 21, and positions of the two installation recesses 22 respectively correspond to the installation holes 13 of the panel 11. Each one of the installation recesses 22 forms a recess wall, and at least one snap-fitting recess 221 is recessed from and formed on the recess wall.

With reference to FIGS. 2 to 5, the illumination module 30 includes at least one light-emitting diode (LED) 31 each being a Dual Inline-Pin (DIP) light-emitting diode. Each one of the at least one light-emitting diode 31 is detachably embedded in a corresponding one of the installation recesses 22 of the handle 20. Each one of the at least one light-emitting diode 31 has a rim 311 and multiple terminal pins 312. The rim 311 surrounds and is formed on an outer wall of the light-emitting diode 31, and snap-fits in the at least one snap-fitting recess 221 of a corresponding one of the installation recesses 22, such that the light-emitting diode 31 and the handle 20 are securely connected to each other. The terminal pins 312 protrude and extend to the corresponding installation holes 13 of the casing 10, and each one of the terminal pins 312 electrically connects with a cable 313, and thereby the light-emitting diode 31 connects with the control module of the power supply via the cable 313. The control module is configured to generate a controlling signal which indicates an operating state of the power supply, and thus, the illuminated handle structure electrically connects with the control module and is capable of emitting a first colored light or a second colored light according to the controlling signal to respond to the operating state of the power supply.

In a specific embodiment of the present invention, the at least one snap-fitting recess 221 includes two snap-fitting recesses 221, and the two snap-fitting recesses 221 are oppositely disposed on the recess wall of the installation recess 22, but the number of the at least one snap-fitting recess 221 is not limited to two, and the main point is to let the light-emitting diode 31 be stably embedded in the installation recess 22.

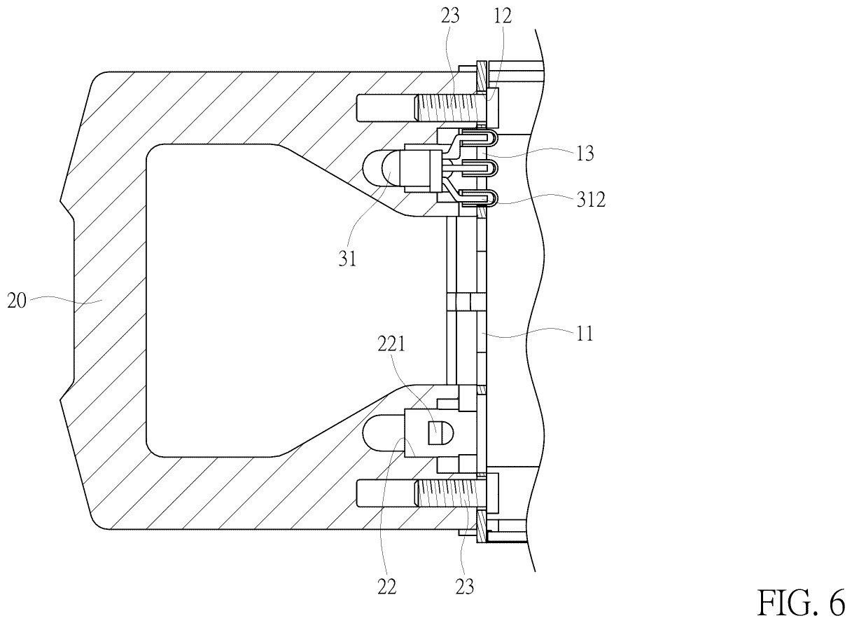

With reference to FIG. 4, in the first preferable embodiment of the present invention, the at least one light-emitting diode 31 includes two light-emitting diodes 31, and the two light-emitting diodes 31 are respectively embedded in the two installation recesses 22 of the handle 20 and capable of emitting lights in two different colors respectively, such as emitting red light and green light respectively, but it is not limited to the two colors. Besides, with reference to FIG. 6, in a second preferable embodiment of the present invention, the at least one light-emitting diode 31 may also only include one light-emitting diode 31. The light-emitting diode 31 is embedded in one of the two installation recesses 22 of the handle 20 and is a bi-color light-emitting diode which is capable of emitting lights in two different colors. To be more precise, the bi-color light-emitting diode is capable of emitting red light and green light, but it is not limited to the two colors. When there is only one light-emitting diode 31, the panel 11 may also only form one secure-connection hole 12 and one installation hole 13 correspondingly, and the handle 20 may only form one installation recess 22 correspondingly. The aforementioned light-emitting diode 31 electrically connects with the control module of the power supply, and the control module would control the color of the light emitted according to the operating state of the power supply, such that the user may recognize the state of the power supply according to the color of the light.

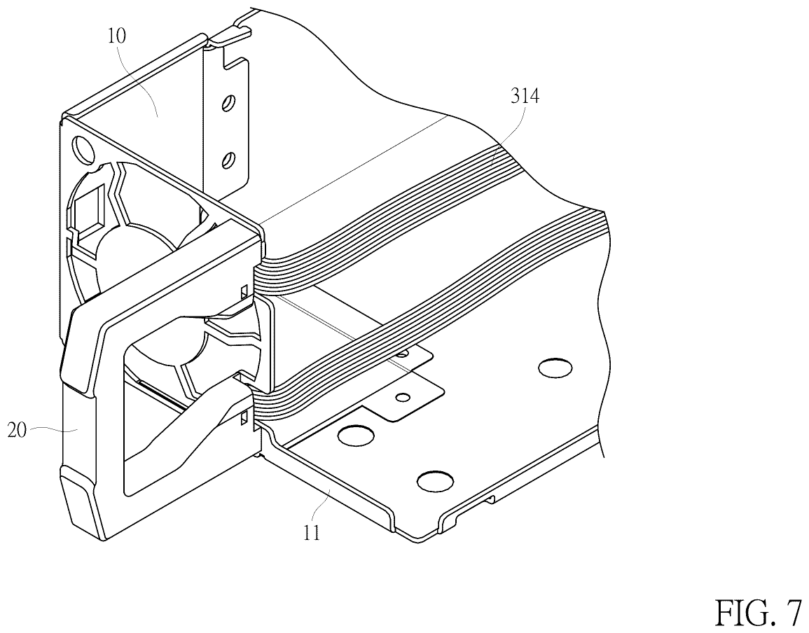

With reference to the third preferable embodiment as shown in FIG. 7, the aforementioned cable 313, which electrically connects with the control module and each one of the terminal pins of the light-emitting diode 31, is replaced with a flexible flat cable (FFC) 314. A thickness of the flexible flat cable 314 is less than that of the cable 313, thus capable of further reducing the space occupied within the power supply.

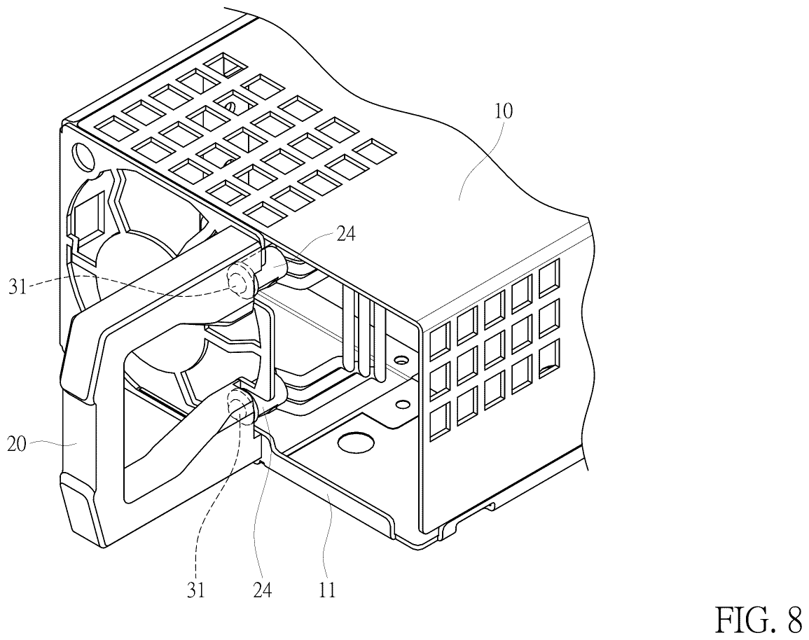

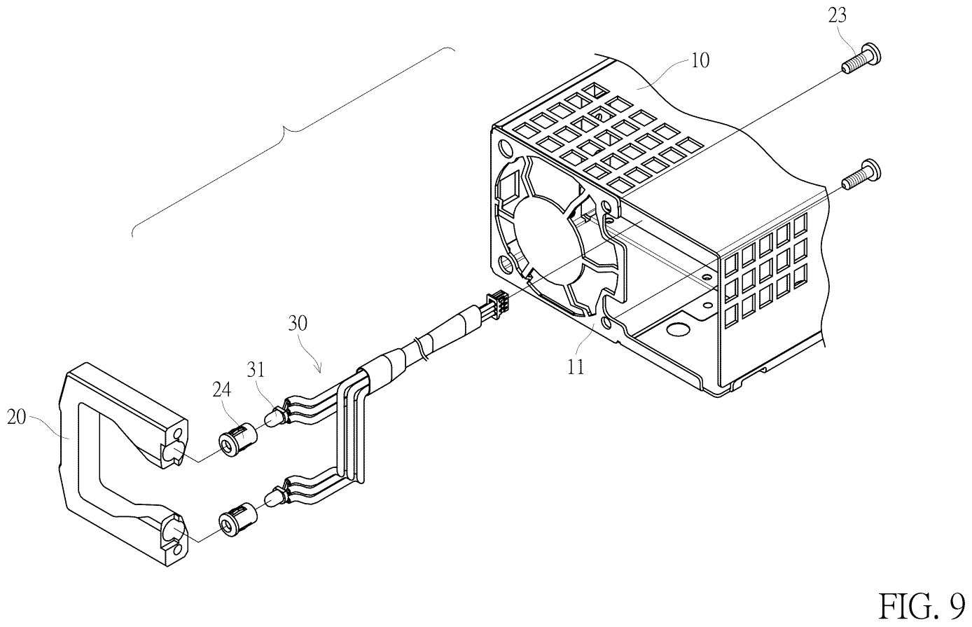

With reference to FIGS. 8 and 9, in a fourth preferable embodiment in accordance with the present invention, each one of the at least one light-emitting diode 31 is indirectly embedded at the handle 20 via a fastening seat 24. The aforementioned each one of the installation recesses 22 and the snap-fitting recesses 221 formed on the recess wall of the installation recess 22 of the handle 20 are formed in the fastening seat 24. Therefore, the assembler is able to assemble each one of the at least one light-emitting diode 31 in a corresponding one of the fastening seats 24 first, and then securely mount the fastening seat 24 into the corresponding installation recess 22 of the handle 20, to achieve the purpose of installing the at least one light-emitting diode 31 in the installation recesses 22 of the handle 20.

However, in contrast, the illuminated handle structures in the aforementioned first, second, and third preferable embodiments omit the fastening seat 24 provided in the aforementioned fourth preferable embodiment, thus being particularly suitable for the casing 10 that has a certain size, such as a smaller size. In addition, omitting the fastening seat 24 would correspondingly omit the assembling components, reduce steps in assembling the power supply, and thus obtain beneficial effects of saving manufacturing cost and without the concern of being incapable of installing the light-emitting diode 31 due to loss of the components (i.e., the fastening seat 24).

The advantage of the power supply and the illuminated handle structure thereof in this disclosure is provided with Dual Inline-Pin light-emitting diodes 31 to replace the Surface Mount Device light-emitting diodes that have to be provided along with a flexible printed circuit board. Thus, in addition to significantly reducing material costs, damage caused during assembling process can also be reduced, thereby improving yield rate of the product and reducing manufacturing costs.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An illuminated handle structure of a power supply configured to be mounted on a casing of the power supply and comprising:
a handle made of a light transmitting material and being U-shaped, and having:
two secure-connection ends, and each one of the two secure-connection ends including an end surface; and
at least one installation recess recessed from the end surface of at least one of the two secure-connection ends; a recess wall formed within each one of the at least one installation recess, and at least one snap-fitting recess formed on the recess wall; and
an illumination module having at least one light-emitting diode each being a Dual Inline-Pin (DIP) light-emitting diode, and each one of the at least one light-emitting diode detachably embedded in a corresponding one of the at least one installation recess of the handle; each one of the at least one light-emitting diode including:
a rim surrounding and formed on an outer wall surface of the at least one light-emitting diode, and snap-fitting in the at least one snap-fitting recess of the corresponding installation recess; and
multiple terminal pins, and each one of the terminal pins electrically connecting with a cable.

2. The illuminated handle structure of the power supply as claimed in claim 1, wherein, the cable is a flexible flat cable, and the flexible flat cable electrically connects with each one of the terminal pins of the at least one light-emitting diode.

3. The illuminated handle structure of the power supply as claimed in claim 1, wherein, the at least one installation recess of the handle includes two installation recesses, and the two installation recesses are respectively recessed from the end surfaces of the two secure-connection ends.

4. The illuminated handle structure of the power supply as claimed in claim 2, wherein, the at least one installation recess of the handle includes two installation recesses, and the two installation recesses are respectively recessed from the end surfaces of the two secure-connection ends.

5. The illuminated handle structure of the power supply as claimed in claim 3, wherein, the at least one light-emitting diode includes two light-emitting diodes, and the two light-emitting diodes are respectively embedded in the two installation recesses of the handle.

6. The illuminated handle structure of the power supply as claimed in claim 4, wherein, the at least one light-emitting diode includes two light-emitting diodes, and the two light-emitting diodes are respectively embedded in the two installation recesses of the handle.

7. The illuminated handle structure of the power supply as claimed in claim 1, wherein, the at least one light-emitting diode includes one light-emitting diode, and the light-emitting diode is embedded in one of the at least one installation recess of the handle.

8. The illuminated handle structure of the power supply as claimed in claim 2, wherein, the at least one light-emitting diode includes one light-emitting diode, and the light-emitting diode is embedded in one of the at least one installation recess of the handle.

9. A power supply comprising:
a casing including a panel;
a fan mounted at an inner side of the panel and exposed to an exterior of the casing through the panel;
a receptacle configured to receive an external power source;
a transformer module mounted in the casing and electrically connecting with the receptacle, and the transformer module configured to transform the external power source into a direct-current power source;
a direct current output connector electrically connected to the transformer module and configured to export the direct-current power source;
a control module configured to generate a controlling signal, and the controlling signal indicating an operating state of the power supply; and
an illuminated handle structure mounted on the panel of the casing and electrically connecting with the control module, and the illuminated handle structure configured to show the operating state of the power supply according to the controlling signal via emitting a first colored light or a second colored light; and
wherein, the illuminated handle structure comprises:
a handle made of a light transmitting material and being U-shaped, and having:
two secure-connection ends, and each one of the two secure-connection ends including an end surface; and
at least one installation recess recessed from the end surface of at least one of the two secure-connection ends; a recess wall formed within each one of the at least one installation recess, and at least one snap-fitting recess formed on the recess wall; and
an illumination module having at least one light-emitting diode each being a Dual Inline-Pin (DIP) light-emitting diode, and each one of the at least one light-emitting diode detachably embedded in a corresponding one of the at least one installation recess of the handle; each one of the at least one light-emitting diode including:
a rim surrounding and formed on an outer wall surface of the at least one light-emitting diode, and snap-fitting in the at least one snap-fitting recess of the corresponding installation recess; and
multiple terminal pins, and each one of the terminal pins electrically connecting with a cable.

10. The power supply as claimed in claim 9, wherein, the cable is a flexible flat cable, and the flexible flat cable electrically connects with each one of the terminal pins of the at least one light-emitting diode.

11. The power supply as claimed in claim 9, wherein, the at least one installation recess of the handle includes two installation recesses, and the two installation recesses are respectively recessed from the end surfaces of the two secure-connection ends.

12. The power supply as claimed in claim 10, wherein, the at least one installation recess of the handle includes two installation recesses, and the two installation recesses are respectively recessed from the end surfaces of the two secure-connection ends.

13. The power supply as claimed in claim 11, wherein, the at least one light-emitting diode includes two light-emitting diodes, and the two light-emitting diodes are respectively embedded in the two installation recesses of the handle.

14. The power supply as claimed in claim 12, wherein, the at least one light-emitting diode includes two light-emitting diodes, and the two light-emitting diodes are respectively embedded in the two installation recesses of the handle.

15. The power supply as claimed in claim 9, wherein, the at least one light-emitting diode includes one light-emitting diode, and the light-emitting diode is embedded in one of the at least one installation recess of the handle.

16. The power supply as claimed in claim 10, wherein, the at least one light-emitting diode includes one light-emitting diode, and the light-emitting diode is embedded in one of the at least one installation recess of the handle.
